(19) United States
(12) Patent Application Publication
(10) Pub. No.: US 2026/0138567 A1
(43) Pub. Date: May 21, 2026

(54) VEHICLE LENS CLEANING ASSEMBLY

(71) Applicant: Ford Global Technologies, LLC, Dearborn, MI (US)

(72) Inventors: Raul Alberto Davila Vega, Mexico City (MX); Alejandro Jonathan Lopez Lopez, Mexico City (MX); David Hernandez Morfin, Mexico City (MX); Oscar Ussiel Martinez Cardenas, Mexico City (MX)

(21) Appl. No.: 18/949,455

(22) Filed: Nov. 15, 2024

(51) Int. Cl. B60S 1/56; B60S 1/38

(52) U.S. Cl. CPC B60S 1/56; B60S 1/38; B60S 2001/3836

(57) ABSTRACT

A vehicle camera assembly has lens and a curved wiper that is rotatable back-and-forth between a retracted position and a deployed position. The curved wiper directly contacts the lens when the curved wiper is rotated from the retracted position to the deployed position. The curved wiper can move along an arcuate path that mimics a curvature of the lens.

### TECHNICAL FIELD

This disclosure relates generally to a lens of a vehicle and, more particularly, to cleaning the lens using a wiper that directly contacts the lens.

### BACKGROUND

Many vehicles include cameras and other devices having a lens. An operator of the vehicle can view images captured by a camera to, for example, better understand areas around the vehicle. There is a desire to keep the area in front of the lens as clear as possible.

### SUMMARY

In some aspects, the techniques described herein relate to a vehicle lens cleaning assembly, including: a lens; and a curved wiper that is rotatable back-and-forth between a retracted position and a deployed position, the curved wiper directly contacting the lens when the curved wiper is rotated from the retracted position to the deployed position.

In some aspects, the techniques described herein relate to a vehicle lens cleaning assembly, wherein the curved wiper includes a protrusion that directly contacts the lens when the curved wiper is rotated from the retracted position to the deployed position.

In some aspects, the techniques described herein relate to a vehicle lens cleaning assembly, wherein the protrusion extends from a shield portion of the curved wiper, the protrusion extending from the shield portion toward the lens.

In some aspects, the techniques described herein relate to a vehicle lens cleaning assembly, wherein the protrusion has a first material composition and the shield portion has a second material composition that is different than the first material composition.

In some aspects, the techniques described herein relate to a vehicle lens cleaning assembly, wherein the second material composition is softer than the first material composition.

In some aspects, the techniques described herein relate to a vehicle lens cleaning assembly, wherein the protrusion is softer than the shield portion.

In some aspects, the techniques described herein relate to a vehicle lens cleaning assembly, wherein the lens is curved.

In some aspects, the techniques described herein relate to a vehicle lens cleaning assembly, wherein the curved wiper moves along a arcuate path when rotating between the retracted position and the deployed position, wherein the arcuate path mimics a curvature of an outer surface of the lens.

In some aspects, the techniques described herein relate to a vehicle lens cleaning assembly, wherein an outer surface of the lens is curved, the curved wiper directly contacting the outer surface when the curved wiper is rotated from the retracted position to the deployed position.

In some aspects, the techniques described herein relate to a vehicle lens cleaning assembly, wherein the curved wiper directly contacts the lens when the curved wiper is rotated from the deployed position to the retracted position.

In some aspects, the techniques described herein relate to a vehicle lens cleaning assembly, wherein the lens is a lens of backup camera.

In some aspects, the techniques described herein relate to a vehicle lens cleaning assembly, further including an actuator, a shaft, and a connecting rod, the connecting rod rotatably coupling the shaft to the curved wiper, wherein the actuator is configured to rotate the shaft to rotate the curved wiper.

In some aspects, the techniques described herein relate to a vehicle lens cleaning assembly, further including a pin that is received within a slot to rotatably couple the connecting rod to the curved wiper.

In some aspects, the techniques described herein relate to a vehicle lens cleaning assembly, wherein the curved wiper includes the pin.

In some aspects, the techniques described herein relate to a vehicle lens cleaning assembly, further including a housing that holds the curved wiper, the housing including at least one first slot on a first side of the curved wiper, and at least one second slot on an opposite second side of the curved wiper, the curved wiper including at least one first pin on the first side that is received within the at least one first slot, and at least one second pin on the second side that is received within the at least one second slot.

In some aspects, the techniques described herein relate to a vehicle lens cleaning assembly, further including a connecting rod coupled to the at least one first pin, the connecting rod configured to drive rotation of the curved wiper back and forth between the retracted position and the deployed position.

In some aspects, the techniques described herein relate to a vehicle lens cleaning assembly, wherein the lens is a camera lens

In some aspects, the techniques described herein relate to a vehicle lens cleaning assembly, including: a lens; and a wiper that is configured to move along an arcuate path while contacting the lens, the wiper configured to move along the arcuate path back-and-forth between a retracted position and a deployed position, the wiper directly contacting the lens when the wiper is rotated from the retracted position to the deployed position.

In some aspects, the techniques described herein relate to a vehicle lens cleaning assembly, wherein the wiper is a curved wiper having a protrusion and a curved shield, the protrusion configured to contact the lens.

In some aspects, the techniques described herein relate to a vehicle lens cleaning assembly, wherein the protrusion is softer than the curved shield.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle having a camera assembly according to an exemplary aspect of the present disclosure.

FIG. 2 illustrates a closeup perspective view of the camera assembly of FIG. 1 with a curved wiper of the camera in a retracted position.

FIG. 3 illustrates the perspective view of the camera assembly of FIG. 2 with the curved wiper in the deployed position.

FIG. 4 illustrates an expanded view of the camera assembly of FIG. 2.

FIG. 5 illustrates a section view of the camera assembly taken at line 4–4 in FIG. 2.

FIGS. 6A-6C illustrates section views of the camera assembly with the curved wiper in various positions.

### DETAILED DESCRIPTION

This disclosure details exemplary camera assemblies for a vehicle. The camera assemblies incorporate a curved wiper. Debris can be removed or reduced from a lens of the camera assembly by rotating the curved wiper along a arcuate path that tracks an outer surface of the lens. The curved wiper can directly contact the lens.

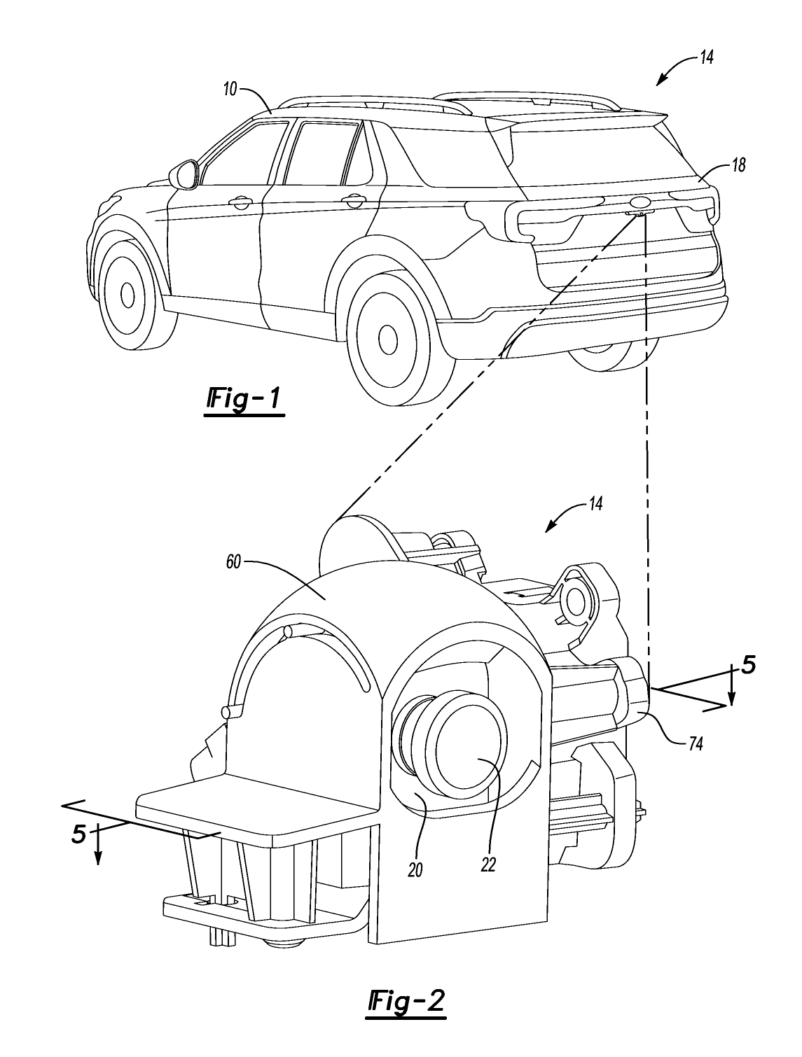

With reference now to FIGS. 1-4, a vehicle 10 includes a camera assembly 14 mounted within a rear door 18 of the vehicle 10. The example camera assembly 14 is a backup camera that can capture images of areas aft of the vehicle 10. The vehicle 10 can include various other camera assemblies including, but not limited to, front view camera assemblies and side view camera assemblies. The teachings of this disclosure, while described in connection with the exemplary camera assembly 14, should be considered to extend to any camera assembly of a vehicle.

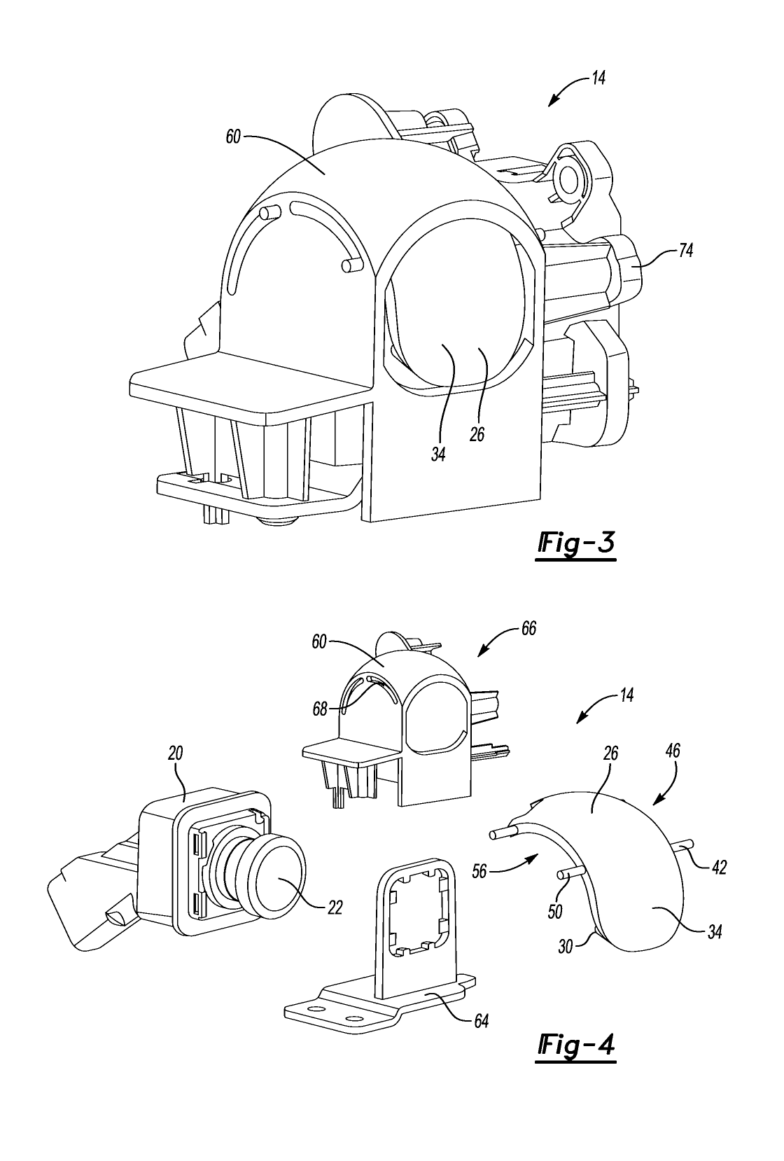

The camera assembly 14 includes a camera 20, a lens 22 of the camera 20, and a curved wiper 26. The curved wiper 26 is rotatable back-and-forth between a retracted position shown in FIG. 2 and a deployed position as shown in FIG. 3.

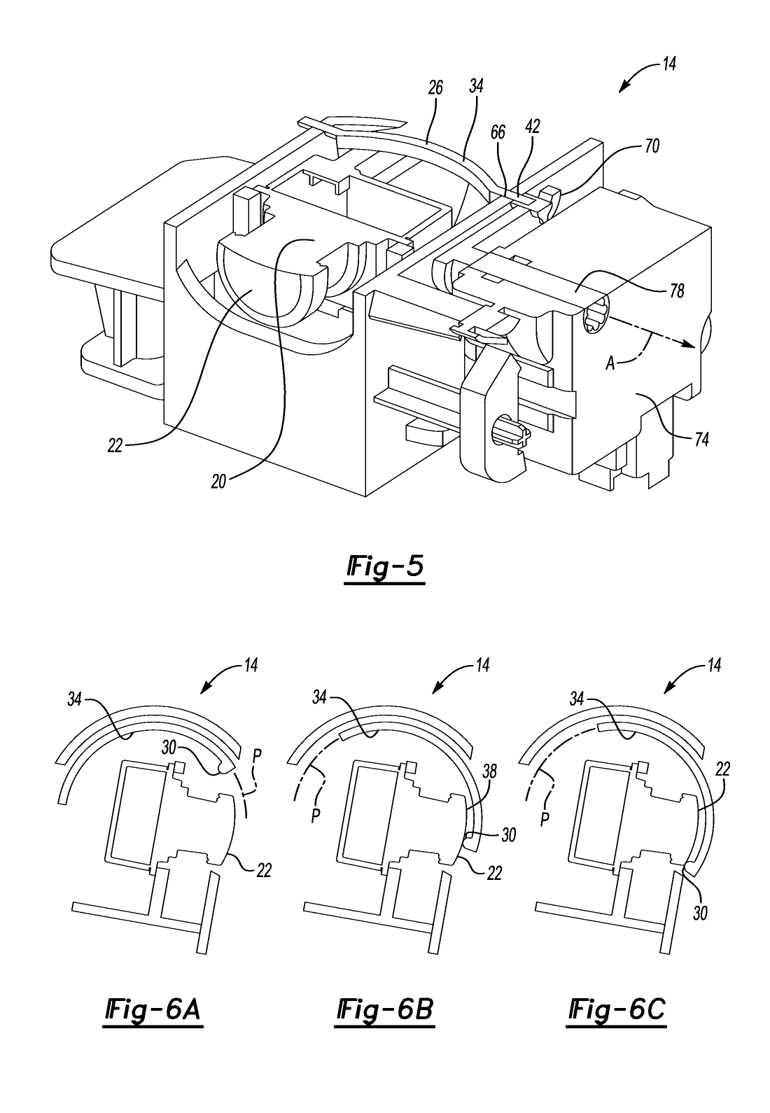

With reference now to FIGS. 5-6C, and continuing reference to FIGS. 1-4, the curved wiper 26 includes a protrusion 30 and a shield portion 34. The protrusion 30 projects from the shield portion 34 toward the lens 22. The protrusion 30 directly contacts the lens 22 when the curved wiper 26 is rotated back-and-forth between the retracted position and the deployed position. Contact between the protrusion 30 and the lens 22 can reduce or eliminate debris on the lens 22. In this example, the curved wiper 26 cleans the lens 22 of the camera 20. In other examples, the curved wiper can clean another type of lens, such as a lens of a sensor or a lens of a light.

In some examples, a cleaning agent, such as a liquid cleaner, can be sprayed onto the lens 22 prior to the curved wiper 26 rotating, during the rotation of the curved wiper 26, or both. The cleaning agent can facilitate removal of debris from the lens 22 when the curved wiper 26 is rotated back-and-forth between the retracted position and the deployed position.

The curved wiper 26 moves along an arcuate path P when rotated back-and-forth between the retracted position and the deployed position. The lens 22 has a curved profile 38. In this example, the arcuate path P has the same curvature as the curved profile 38 of the lens 22. That is, a curvature of the arcuate path P mimics the curved profile 38 of the lens 22.

In this example, the protrusion 30 has a first material composition and the shield portion 34 has a second material composition that is different than the first material composition. In some examples, the material composition of the protrusion 30 can be softer than the shield portion 34. The protrusion 30 could be a rubber material while the shield portion 34 is a harder polymer-based material, for example. Making the protrusion 30 relatively soft can help to maintain the protrusion 30 in contact with the lens 22 and can thus facilitate removal of debris.

In the exemplary embodiment, the curved wiper 26 includes at least one first pin 42 on a first side 46 of the curved wiper 26. The curved wiper 26 additionally includes at least one second pin 50 on an opposite second side 56 of the curved wiper 26.

The camera assembly 14 includes a housing 60 that holds the camera 20 and the curved wiper 26. Within the housing 60, the camera 20 can be held in position by a camera holder 64.

To hold the curved wiper 26 within the housing 60, the first pins 42 on the first side 46 are received within at least one slot 66 of the housing 60. The second pins 50 on the second side 56 are similarly received within slots 68 of the housing 60. In other examples, one or more pins of the housing 60 could extend into slots of the curved wiper 26.

The curved wiper 26 is movable relative to the housing 60 when the curved wiper 26 is rotated back-and-forth between the retracted position and the deployed position. To move the example curved wiper 26, one of the first pins 42 extends through the slot 66 and is coupled to a connecting rod 70. The example camera assembly 14 then includes an actuator 74 that is actuated to rotate a shaft 78. The connecting rod 70 is coupled to the shaft 78 and rotate about an axis A when driven by the shaft.

Rotation of the connecting rod 70 slides the pin 42 within the slot 66 to move the curved wiper 26. As can be appreciated, rotation about the axis A in a first direction rotates the curved wiper 26 in the first direction from the retracted position to a deployed position. Rotation of the shaft 78 in an opposite second direction caused the curved wiper 26 to rotate from the deployed position back to the retracted position.

To clean the lens 22, the actuator 74 can be activated several times to cause multiple rotations of the shaft 78 about the axis A back and forth in the first and second directions. These rotations can move the curved wiper 26 causing the protrusion 30 to move repeatedly over areas of the lens 22.

In an example method of operation, the vehicle 10 may include a controller capable of recognizing that the view provided by the lens 22 is obstructed by debris. Instead or additionally, an operator of the vehicle may view an image provided by the camera assembly 14 and recognize the presence of debris on the lens 22. In response, the operator can activate a button within the vehicle 10 to start a cleaning process for the lens 22. Alternatively, if debris on the lens 22 are automatically recognized by the vehicle 10, the cleaning process can be initiated automatically.

During the cleaning process, if the vehicle 10 is equipped with a camera jet washer, fluid can be sprayed onto the lens 22. In some examples, the fluid may be sprayed onto the lens 22 for about 0.5 seconds.

As the lens 22 is sprayed or after the camera 20 is sprayed, the actuator 74 can be activated to rotate the shaft 78 and moves the curved wiper 26 back-and-forth between the retracted position and the deployed position. The protrusion 30 contacting the lens 22 can remove debris from the lens 22 during the movement of the curved wiper 26.

In some examples, the curved wiper 26 can be moved to the deployed position to protect the lens 22. For example, the curved wiper 26 could move to and then stay in the deployed position when the vehicle 10 is parked.

Features of the disclosed examples include cleaning a lens of a vehicle camera utilizing a wiper assembly that directly contacts the lens and that travels along a arcuate path to track a curvature of the lens. In some examples, the movement can be considered as an eyelid-type movement.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle lens cleaning assembly, comprising:
a lens; and
a curved wiper that is rotatable back-and-forth between a retracted position and a deployed position, the curved wiper directly contacting the lens when the curved wiper is rotated from the retracted position to the deployed position.

2. The vehicle lens cleaning assembly of claim 1, wherein the curved wiper comprises a protrusion that directly contacts the lens when the curved wiper is rotated from the retracted position to the deployed position.

3. The vehicle lens cleaning assembly of claim 2, wherein the protrusion extends from a shield portion of the curved wiper, the protrusion extending from the shield portion toward the lens.

4. The vehicle lens cleaning assembly of claim 3, wherein the protrusion has a first material composition and the shield portion has a second material composition that is different than the first material composition.

5. The vehicle lens cleaning assembly of claim 4, wherein the second material composition is softer than the first material composition.

6. The vehicle lens cleaning assembly of claim 3, wherein the protrusion is softer than the shield portion.

7. The vehicle lens cleaning assembly of claim 1, wherein the lens is curved.

8. The vehicle lens cleaning assembly of claim 1, wherein the curved wiper moves along a arcuate path when rotating between the retracted position and the deployed position, wherein the arcuate path mimics a curvature of an outer surface of the lens.

9. The vehicle lens cleaning assembly of claim 1, wherein an outer surface of the lens is curved, the curved wiper directly contacting the outer surface when the curved wiper is rotated from the retracted position to the deployed position.

10. The vehicle lens cleaning assembly of claim 1, wherein the curved wiper directly contacts the lens when the curved wiper is rotated from the deployed position to the retracted position.

11. The vehicle lens cleaning assembly of claim 1, wherein the lens is a lens of backup camera.

12. The vehicle lens cleaning assembly of claim 1, further comprising an actuator, a shaft, and a connecting rod, the connecting rod rotatably coupling the shaft to the curved wiper, wherein the actuator is configured to rotate the shaft to rotate the curved wiper.

13. The vehicle lens cleaning assembly of claim 12, further comprising a pin that is received within a slot to rotatably couple the connecting rod to the curved wiper.

14. The vehicle lens cleaning assembly of claim 13, wherein the curved wiper includes the pin.

15. The vehicle lens cleaning assembly of claim 1, further comprising a housing that holds the curved wiper, the housing including at least one first slot on a first side of the curved wiper, and at least one second slot on an opposite second side of the curved wiper, the curved wiper including at least one first pin on the first side that is received within the at least one first slot, and at least one second pin on the second side that is received within the at least one second slot.

16. The vehicle lens cleaning assembly of claim 15, further comprising a connecting rod coupled to the at least one first pin, the connecting rod configured to drive rotation of the curved wiper back and forth between the retracted position and the deployed position.

17. The vehicle lens cleaning assembly of claim 15, wherein the lens is a camera lens.

18. A vehicle lens cleaning assembly, comprising:
a lens; and
a wiper that is configured to move along an arcuate path while contacting the lens, the wiper configured to move along the arcuate path back-and-forth between a retracted position and a deployed position, the wiper directly contacting the lens when the wiper is rotated from the retracted position to the deployed position.

19. The vehicle lens cleaning assembly of claim 18, wherein the wiper is a curved wiper having a protrusion and a curved shield, the protrusion configured to contact the lens.

20. The vehicle lens cleaning assembly of claim 19, wherein the protrusion is softer than the curved shield.
